(19) United States
(12) Patent Application Publication
(10) Pub. No.: US 2024/0337171 A1
(43) Pub. Date: Oct. 10, 2024

(54) METHODS FOR PURIFYING CARBON DIOXIDE-CONTAINING FLUIDS WITHIN SUBTERRANEAN AQUIFERS

(71) Applicant: SAUDI ARABIAN OIL COMPANY, Dhahran (SA)

(72) Inventors: Bora YALCIN, Thuwal (SA); Abdulaziz S. AL-QASIM, Dhahran (SA)

(73) Assignee: SAUDI ARABIAN OIL COMPANY, Dhahran (SA)

(21) Appl. No.: 18/297,975

(22) Filed: Apr. 10, 2023

(51) Int. Cl. E21B 41/00; C01B 32/50

(52) U.S. Cl. CPC E21B 41/0064; C01B 32/50

(57) ABSTRACT

Methods for purifying a fluid may include injecting an impure fluid comprising carbon dioxide and at least one impurity into a first subterranean aquifer. The impure fluid may be circulated within the first subterranean aquifer for a period of time sufficient to separate at least a portion of the at least one impurity from the carbon dioxide to produce an at least partially purified fluid comprising the carbon dioxide, the at least partially purified fluid having a lower concentration of the at least one impurity than the impure fluid. The at least partially purified fluid may be removed from the first subterranean aquifer, wherein at least a portion of the at least one impurity remains entrained within the first subterranean aquifer.

### FIELD OF THE DISCLOSURE

The present disclosure relates generally to removal of impurities from carbon dioxide-containing fluids and, more particularly, to methods of removing impurities from carbon dioxide-containing fluids through injection into a subsurface aquifer within a subterranean formation.

### BACKGROUND OF THE DISCLOSURE

Natural gas power plants are a major source of electricity generation in many regions. Considered by many to be a relatively clean energy generation process, natural gas power plants produce considerably less carbon dioxide than do conventional coal-fired power plants. Although less than what is generated by burning coal, significant amounts of carbon dioxide are still present within the flue gas released through natural gas combustion.

Due to the increasing urgency of limiting greenhouse gas emissions, there is a desire to prevent or limit release of carbon dioxide into the atmosphere, such as carbon dioxide within the flue gas of power plants. One technique for preventing atmospheric release of carbon dioxide is sequestration of the carbon dioxide within a subterranean formation. However, outright sequestration of carbon dioxide may represent inefficient use of this gas. Pure carbon dioxide is considered to be a commodity chemical and may be utilized in a number of different applications. That is, disposal of carbon dioxide through sequestration in a subterranean formation precludes one from generating revenue through sale of the carbon dioxide to an interested entity.

Although carbon dioxide generated in flue gas originating from natural gas power plants offers a potential revenue stream, untreated flue gas produced by natural gas combustion frequently contains impurities such as acid gases and particulates mixed with the carbon dioxide, which may make the flue gas unsuitable for sale. Although purification of the flue gas may be performed, such purification processes may be time-consuming and expensive, which may erode one's potential for generating revenue through sale of the carbon dioxide. Without a suitable sales outlet, a plant operator is then left to capture and store the carbon dioxide to preclude or limit atmospheric release. Thus, a potential revenue source may become a cost center instead due to the presence of impurities.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, methods may comprise injecting an impure fluid comprising carbon dioxide and at least one impurity into a first subterranean aquifer; circulating the impure fluid within the first subterranean aquifer for a period of time sufficient to separate at least a portion of the at least one impurity form the carbon dioxide to produce an at least partially purified fluid comprising the carbon dioxide, the at least partially purified fluid having a lower concentration of the at least one impurity than the impure fluid; and removing the at least partially purified fluid from the first subterranean aquifer; wherein at least a portion of the at least one impurity remains entrained within the first subterranean aquifer.

In another embodiment, methods may comprise injecting an impure fluid comprising carbon dioxide and at least one impurity into a first subterranean aquifer; pressurizing the first subterranean aquifer with the impure fluid; producing a formation fluid from the first subterranean aquifer upon pressurizing the first subterranean aquifer; and circulating the impure fluid within the first subterranean aquifer for a period of time sufficient to separate at least a portion of the at least one impurity from the impure fluid to produce an at least partially purified fluid comprising carbon dioxide, the at least partially purified fluid having a lower concentration of the at least one impurity than the impure fluid.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIGS. 1A-1C are diagrams showing how an impure fluid containing carbon dioxide may be at least partially purified and further manipulated according to the present disclosure.

### DETAILED DESCRIPTION

Embodiments in accordance with the present disclosure generally relate to removing impurities from carbon dioxide-containing fluids and, more particularly, to methods for removing impurities from carbon dioxide-containing fluids through injection into a subterranean aquifer.

As discussed above, carbon dioxide generated through various processes represents a potential revenue stream due to the wide-ranging uses of this gas. However, many commercial processes generate carbon dioxide in impure form, such as flue gas released from natural gas power plants, thereby making the carbon dioxide unsuitable for sale without further purification taking place. Purification processes may be time-consuming and expensive, which may erode one's ability to generate revenue through carbon dioxide sales and may even turn the carbon dioxide into a waste disposal liability.

The present disclosure demonstrates that impure fluids containing carbon dioxide and at least one impurity may be easily purified by taking advantage of natural geological processes that occur in a subterranean formation. In particular, subterranean aquifers, such as deep saline aquifers, may naturally segregate carbon dioxide from impurities, such as hydrogen sulfide, thereby allowing an at least partially purified fluid containing carbon dioxide with increased purity to be recovered from the subterranean aquifer after an extended circulation time. The subterranean aquifer may promote such separations due to the differences in solubility, viscosity, density, and reactivity of the at least one impurity relative to the carbon dioxide and the porosity of the formation within which the subterranean aquifer is located. In at least some instances, the at least one impurity may become entrained within the subterranean aquifer, including through undergoing a chemical reaction with the matrix of the subterranean aquifer, to facilitate separation of the at least one impurity from the impure fluid. The physical and/or chemical entrainment of the at least one impurity within the subterranean aquifer may generate an at least partially purified fluid having a lower concentration of the at least one impurity than the impure fluid. The at least partially purified fluid may then be produced from the subterranean aquifer so that the carbon dioxide may be recovered and potentially sold. The terms “subterranean aquifer” and “subsurface aquifer” may be used interchangeably herein.

As used herein, the term “deep saline aquifer” refers to a porous sedimentary rock formation at least 0.5 km below the Earth's surface that contains water with dissolved salts and/or minerals. Deep saline aquifers may be located within a larger sedimentary basin and be sealed by a cap-rock. Subterranean aquifers located at shallower depths below the earth's surface may contain fresh water, which may be used for drinking water or agricultural purposes in many instances. Deep saline aquifers, due at least to their salinity and depth, arc typically not suitable or feasible for such purposes.

Recovery of at least partially purified carbon dioxide for subsequent sales thereof may be a primary motivator for performing purification of an impure fluid according to the present disclosure in various instances. In some or other examples, injection of an impure fluid containing carbon dioxide into a subterranean aquifer, preferably a deep saline aquifer, may allow geothermal heat to be withdrawn from the subterranean aquifer to generate an additional revenue stream. Deep saline aquifers may be advantageous in this regard due to the higher temperatures at their relatively great depths. In one example, geothermal heat may be withdrawn from a subterranean aquifer when an at least partially purified fluid containing carbon dioxide is withdrawn therefrom. In some or other examples, injection of an impure fluid to the subterranean aquifer may result in displacement of native formation fluid to the surface, from which geothermal heat latent therein may then be withdrawn. At least partially purified carbon dioxide may be recovered from the subterranean aquifer in either case.

Once the at least partially purified fluid containing carbon dioxide has been withdrawn from the subterranean aquifer, the carbon dioxide may then be sold directly or stored until there is sufficient demand for the carbon dioxide. In some examples, the at least partially purified carbon dioxide may be stored within surface containment facilities. In other examples, however, the at least partially purified carbon dioxide may be withdrawn from a first subterranean aquifer (e.g., a deep saline aquifer) and then be reinjected to a second subterranean aquifer (e.g., a fresh water aquifer) that is located at a shallower depth than the first subterranean aquifer. By storing the at least partially purified carbon dioxide at a shallower depth, the carbon dioxide may be more easily accessed when sufficient demand arises. Moreover, by at least partially purifying the carbon dioxide initially in a deep saline aquifer, the risk of contaminating fresh water destined for drinking or agricultural purposes may be significantly reduced.

Accordingly, methods of the present disclosure may comprise: injecting an impure fluid comprising carbon dioxide and at least one impurity into a first subterranean aquifer; circulating the impure fluid within the first subterranean aquifer for a period of time sufficient to separate at least a portion of the at least one impurity from the carbon dioxide to produce an at least partially purified fluid comprising the carbon dioxide; and removing the at least partially purified fluid from the first subterranean aquifer. The at least partially purified fluid has a lower concentration of the at least one impurity than the impure fluid, and at least a portion of the at least one impurity remains entrained within the first subterranean aquifer.

A source of the impure fluid may be a hydrocarbon-based power plant, such as a natural gas power plant utilizing natural gas combustion as a source of energy. For example, the impure fluid may comprise a flue gas obtained from the natural gas power plant. Other suitable impure fluids that may undergo purification according to the present disclosure may include, for example, effluent from a coal-fired power plant, an internal combustion engine, the like, or any combination thereof.

The at least one impurity may comprise an acid gas, such as hydrogen sulfide. Other acid gases, such as sulfur oxides (e.g., sulfur dioxide and/or sulfur trioxide), may also be present. Additional impurities may also be present in impure fluids, such as flue gas, and undergo at least partial separation from carbon dioxide according to the disclosure herein. Such additional impurities may include, but are not limited to, nitrogen, nitrogen oxides, water vapor, particulate matter (e.g., soot), carbon monoxide, oxygen, the like, and any combination thereof. The at least one impurity may represent a minority component of the impure fluid. In non-limiting examples, the at least one impurity may be present in the impure fluid at a concentration of about 0.1 wt % to about 20 wt %, or about 0.1 wt % to about 10 wt %, or about 0.1 wt % to about 5 wt %, or about 5 wt % to about 20 wt %, or about 5 wt % to about 10 wt %, or about 10 wt % to about 20 wt %, based on total mass of the impure fluid. The remainder of the impure fluid may be carbon dioxide.

The impure fluid may be injected to the subterranean formation as a liquid or gas. That is, the impure fluid may comprise carbon dioxide within a mixture of one or more additional gases, or carbon dioxide admixed with one or more impurities within a liquid phase. For example, the impure fluid may comprise a carbonated aqueous fluid also containing dissolved carbon dioxide and one or more impurities. A carbonated aqueous fluid containing one or more impurities may be formed, for example, by capturing flue gas in an aqueous fluid before the flue gas has had an opportunity to exit a vent stack. The aqueous fluid may be obtained from any suitable source such as, but not limited to, fresh water (e.g., stream water, lake water, or municipal treated water), non-potable water such as gray water or industrial process water, sea water, brine, aqueous salt solutions, partially desalinated water, produced water (including brine and other salt water solutions), or any combination thereof. Suitable techniques for discharging the impure fluid into the subterranean aquifer as a liquid or a gas will be familiar to one having ordinary skill in the art.

The subterranean aquifer where the impure fluid is circulated may be a confined aquifer located beneath a cap-rock layer. The cap-rock layer may promote retention of the carbon dioxide within the internal space of the aquifer. The subterranean aquifer may include an area of porous rock where circulation of the impure fluid takes place. The subterranean aquifer may have a capacity sufficient to store a suitable amount of impure fluid for adequate separation of the at least one impurity from the impure fluid. In non-limiting examples, the subterranean aquifer may have a storage capacity of about 100 GtCO₂ (gigatonnes of carbon dioxide) to about 10,000 GtCO₂, or about 100 GtCO₂ to about 1,000 GtCO₂, or about 100 GtCO₂ to about 500 GtCO₂, or about 500 GtCO₂ to about 10,000 GtCO₂, or about 500 GtCO₂ to about 1,000 GtCO₂, or about 1,000 GtCO₂ to about 10,000 GtCO₂.

Preferably, the subterranean aquifer where the impure fluid is circulated and at least partially purified is obtained may comprise a deep saline aquifer. The deep saline aquifer may be located at a depth of about 0.5 km or more, or about 0.6 km or more, or about 0.7 km or more, or about 0.8 km or more, or about 0.9 km or more, or about 1 km or more, or about 1.2 km or more, or about 1.5 km or more, or about 1.7 km or more, or about 2 km or more, such as about 0.5 km to about 1.2 km, or about 0.8 km to about 1.5 km, or about 0.7 km to about 1.2, or about 1 km to about 1.5 km, or about 1 km to about 1.7 km. Preferably, the deep saline aquifer is scaled by a layer of cap-rock at these depths.

Injection of the impure fluid into the subterranean aquifer may occur via one or more injection wells penetrating the subterranean aquifer. The one or more injection wells may penetrate a deeper portion of the subterranean aquifer, for example. That is, the one or more injection wells may feature an outlet within a lower 25% of the subterranean aquifer, or a lower 10% of the subterranean aquifer, or a lower 5% of the subterranean aquifer. It is to be recognized that higher placement of the one or more injection wells within the subterranean aquifer also resides within the scope of the present disclosure. The one or more injection wells may comprise elements such as pumps to facilitate injection of the impure fluid into the subterranean aquifer.

In some examples, injection of the impure fluid to the subterranean aquifer may occur continuously. In some or other examples, the impure fluid may be injected to the subterranean aquifer portion wise (discontinuously).

Following injection of the impure fluid into the subterranean aquifer, the impure fluid may be allowed to circulate within the subterranean aquifer for a period of time sufficient to promote separation of at least a portion of the at least one impurity from the carbon dioxide to produce an at least partially purified fluid. The period of time may vary depending upon the extent of separation desired. In non-limiting examples, the period of time may be about 0.1 years to about 10 years, or about 0.1 years to about 5 years, or about 0.1 years to about 1 year, or about 1 year to about 10 years, or about 1 year to about 5 years, or about 5 years to about 10 years. Following circulation of the impure fluid in the subterranean aquifer for the period of time, a concentration of the at least one impurity may decrease to about 2 wt % or less, or about 1.5 wt % or less, or about 1 wt % or less, or about 0.5 wt % or less, or about 0.1 wt % or less, based on a total mass of the at least partially purified fluid.

One or more production wells penetrating the subterranean aquifer may be used to remove the at least partially purified fluid from the subterranean aquifer and ensure that the subterranean aquifer does not become over-pressurized. In non-limiting examples, the one or more production wells may penetrate a shallower portion of the subterranean aquifer. That is, the one or more injection wells may feature an outlet within an upper 25% of the subterranean aquifer, or an upper 10% of the subterranean aquifer, or an upper 5% of the subterranean aquifer. By having the one or more production wells located in an upper (shallower) portion of the subterranean aquifer, natural buoyancy of the carbon dioxide may facilitate production of the purified fluid. Although injection of the impure fluid and production of the at least partially purified fluid may take place by separate injection wells and production wells, it is to be appreciated that one or more wells may be alternately used for both injection and production in the disclosure herein.

In some examples, production of the at least partially purified fluid may occur continuously. In some or other examples, production of the at least partially purified fluid may occur portionwise (discontinuously). In some or other examples, at least a portion of the at least partially purified fluid may be produced and then returned to the subterranean aquifer, such as if insufficient purification has taken place and/or to maintain pressure within the subterranean aquifer.

After the impure fluid has circulated in the subterranean aquifer to sufficiently separate at least a portion of the at least one impurity from the carbon dioxide, an at least partially purified fluid may be produced from the subterranean reservoir. In non-limiting examples, the at least partially purified fluid may be utilized in other applications, for example, enhanced oil recovery, geothermal energy withdrawal, formation fluid production, or any combination thereof.

In some or other examples, the at least partially purified fluid may be produced from a first subterranean aquifer and then be transferred to a second subterranean aquifer located at a shallower depth than the first subterranean aquifer. In non-limiting examples, the second subterranean aquifer may comprise a subterranean aquifer located at a depth of about 0.5 km or less, such as at a depth of about 0.1 km to about 0.45 km, or about 0.1 km to about 0.25 km. The second subterranean aquifer may be a freshwater aquifer in particular examples. By transferring the at least partially purified fluid to the second subterranean aquifer, the at least partially purified fluid may be more easily accessed for recovery when sale or use of the carbon dioxide is desired. Moreover, because at least a majority of the at least one impurity has been separated from the carbon dioxide, the risk of contaminating freshwater within the second subterranean aquifer may be significantly decreased.

When used for enhanced oil recovery, the at least partially purified fluid may be injected into a hydrocarbon-bearing subterranean formation. Injecting the at least partially purified fluid into the hydrocarbon-bearing subterranean formation may drive (mobilize) hydrocarbons in the hydrocarbon-bearing subterranean formation toward a hydrocarbon production well. The at least partially purified fluid may dissolve in the hydrocarbons, thus lowering the viscosity of the hydrocarbons and allowing for enhanced oil recovery to occur.

The subterranean aquifer may be located at a depth from the Earth's surface at which the aquifer temperature is elevated compared to the surface temperature, and heat may be transferred to the impure fluid and/or the at least partially purified fluid. In this instance, the impure fluid or the at least partially purified fluid may function as a working fluid of a geothermal energy recovery process by absorbing the geothermal energy contained in the subterranean aquifer. Following the removal of the at least partially purified fluid from the subterranean aquifer, the geothermal energy absorbed by the at least partially purified fluid may be withdrawn and provided to a process in need thereof. For example, the withdrawn geothermal heat may be utilized in a geothermal heating process.

In some instances, injection of the impure fluid into the subterranean aquifer may pressurize the subterranean aquifer, thereby promoting production of a formation fluid from the subterranean reservoir by one or more production wells. Geothermal energy may be similarly withdrawn from the subterranean aquifer via the formation fluid following production thereof. The impure fluid may continue to circulate within the subterranean aquifer within the subterranean aquifer to facilitate generation of an at least partially purified fluid containing carbon dioxide. When the at least partially purified fluid is produced from the subterranean aquifer, at least some additional geothermal energy may be withdrawn from the subterranean aquifer and distributed once returned to the earth's surface.

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

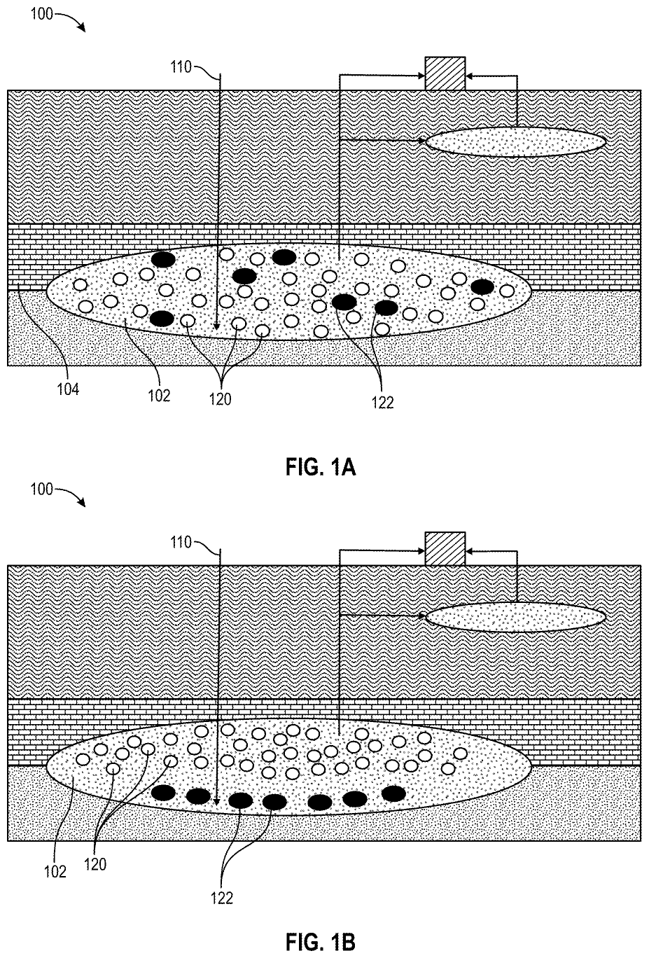

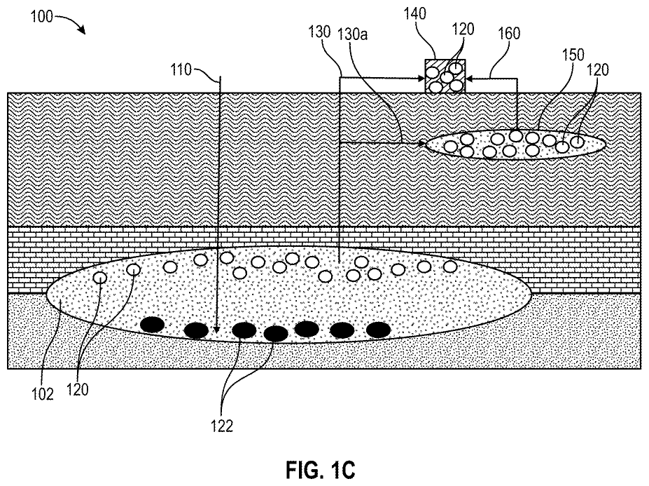

FIGS. 1A-1C are diagrams showing how an impure fluid containing carbon dioxide may be at least partially purified and further manipulated according to the present disclosure. As shown in FIG. 1A, an impure fluid is injected into subterranean aquifer 102 located within subterranean formation 100 and overlaid by cap-rock 104. The impure fluid is injected to subterranean aquifer 102 via injection well 110, which terminates near the bottom of subterranean aquifer 102. After the impure fluid is discharged in subterranean aquifer 102, carbon dioxide 120 and impurities 122 are distributed largely at random therein.

As shown in FIG. 1B, after the impure fluid is circulated in subterranean aquifer 102 for a period of time, carbon dioxide 120 and impurities 122 may begin to segregate from one another within subterranean aquifer 102. Carbon dioxide 120 may rise to an upper portion of subterranean aquifer 102 due it the relative buoyancy thereof.

Once a sufficient degree of separation of carbon dioxide 120 and impurities 122 has taken place with subterranean aquifer 102, production of an at least partially purified fluid containing at least a portion of carbon dioxide 120 may take place via production well 130. As shown in FIG. 1C, at least a portion of carbon dioxide 120 may optionally remain in subterranean aquifer 102 while the remainder is being produced. An inlet of production well 130 may reside near the top of subterranean aquifer 102 so that natural buoyancy of carbon dioxide 120 may facilitate production. As shown, production well 130 may deliver carbon dioxide 120 to surface facility 140, wherein carbon dioxide 120 may be further processed or utilized. Alternately or additionally, at least a portion of carbon dioxide 120 may be diverted by branch line 130a to subterranean aquifer 150, which may be a fresh water subterranean aquifer. The portion of carbon dioxide 120 stored in subterranean aquifer 150 may be delivered to surface facility 140 via production well 160 at a desired time once a demand for carbon dioxide 120 arises.

Embodiments disclosed herein include:
A. Methods for purifying a fluid. The methods include: injecting an impure fluid including carbon dioxide and at least one impurity into a first subterranean aquifer; circulating the impure fluid within the first subterranean aquifer for a period of time sufficient to separate at least a portion of the at least one impurity from the carbon dioxide to produce an at least partially purified fluid including the carbon dioxide, the at least partially purified fluid having a lower concentration of the at least one impurity than the impure fluid; and removing the at least partially purified fluid from the first subterranean aquifer; wherein at least a portion of the at least one impurity remains entrained within the first subterranean aquifer.
B. Methods for purifying a fluid. The methods include: injecting an impure fluid including carbon dioxide and at least one impurity into a first subterranean aquifer; pressurizing the first subterranean aquifer with the impure fluid; producing a formation fluid from the first subterranean aquifer upon pressurizing the first subterranean aquifer; and circulating the impure fluid within the first subterranean aquifer for a period of time sufficient to separate at least a portion of the at least one impurity from the impure fluid to produce an at least partially purified fluid including carbon dioxide, the at least partially purified fluid having a lower concentration of the at least one impurity than the impure fluid.

Each of embodiments A and B may have one or more of the following additional elements in any combination:

Element 1: wherein the at least one impurity comprises hydrogen sulfide.

Element 2: wherein the first subterranean aquifer is a deep saline aquifer.

Element 3: wherein the method further comprises reinjecting the at least partially purified fluid into a second subterranean aquifer located at a shallower depth than the first subterranean aquifer.

Element 4: wherein the period of time is about 0.1 years to about 10 years.

Element 5: wherein a concentration of the at least one impurity in the impure fluid is about 0.1 wt % to about 20 wt %.

Element 6: wherein a concentration of the at least one impurity in the at least partially purified fluid is about 2 wt % or less.

Element 7: wherein a source of the impure fluid is a hydrocarbon-based power plant.

Element 8: wherein the method further comprises absorbing geothermal energy from the first subterranean aquifer into the at least partially purified fluid; and withdrawing the geothermal energy from the at least partially purified fluid upon removing the at least partially purified fluid from the first subterranean aquifer.

Element 9: wherein the method further comprises pressurizing the first subterranean aquifer with the impure fluid; and producing a formation fluid from the first subterranean aquifer upon pressurizing the first subterranean aquifer with the impure fluid.

Element 10: wherein the method further comprises withdrawing geothermal energy from the first subterranean aquifer within the formation fluid produced from the first subterranean aquifer.

Element 11: wherein the method further comprises absorbing additional geothermal energy from the first subterranean aquifer into the at least partially purified fluid; and withdrawing the additional geothermal energy from the at least partially purified fluid upon removal of the at least partially purified fluid from the first subterranean aquifer.

Element 12: wherein the method further comprises injecting the at least partially purified fluid into a hydrocarbon-bearing subterranean formation in conjunction with an enhanced oil recovery process.

Element 13: wherein the method further comprises removing the at least partially purified fluid form the first subterranean aquifer; wherein at least a portion of the at least one impurity remains entrained within the first subterranean aquifer.

Element 14: wherein the method further comprises: absorbing geothermal energy from the first subterranean aquifer into the at least partially purified fluid; and withdrawing the geothermal energy from the at least partially purified fluid upon removing the at least partially purified fluid from the first subterranean aquifer.

Element 15: wherein the at least one impurity comprises hydrogen sulfide.

Element 16: wherein the first subterranean aquifer is a deep saline aquifer.

Element 17: wherein the method further comprises reinjecting the at least partially purified fluid into a second subterranean aquifer located at a shallower depth than the first subterranean aquifer.

Element 18: wherein a concentration of the at least one impurity in the at least partially purified fluid is about 2 wt % or less.

Element 19: wherein the formation fluid absorbs geothermal heat from the first subterranean aquifer, the method further comprising withdrawing the geothermal heat from the formation fluid after production of the formation fluid from the first subterranean aquifer.

By way of non-limiting example, exemplary combinations applicable to A and B include, but are not limited to: 1 and 2; 1 and 3; 1 and 4; 1 and 5; 1 and 6; 1 and 7; 1 and

Element 8; 1 and 9; 1 and 12; 2 and 3; 2 and 4; 2 and 5; 2 and 6; 2 and 7; 2 and 8; 2 and 9; 2 and 13; 3 and 4; 3 and 5; 3 and 6; 3 and 7; 3 and 8; 3 and 9; 3 and 12; 4 and 5; 4 and 6; 4 and 7; 4 and 8; 4 and 9; 4 and 12; 5 and 6; 5 and 7; 5 and 8; 5 and 9; 5 and 12; 6 and 7; 6 and 8; 6 and 9; 6 and 12; 7 and 8; 7 and 9; 7 and 12; 8 and 9; 8 and 12; 9 and 10; 9 and 11; 9 and 12; 10 and 11; 10 and 12; 11 and 12; 13 and 14; 13 and 15; 13 and 16; 13 and 17; 13 and 18; 13 and 19; 14 and 15; 14 and 16; 14 and 17; 14 and 18; 14 and 19; 15 and 16; 15 and 17; 15 and 18; 15 and 19; 16 and 17; 16 and 18; 16 and 19; 17 and 19; and 18 and 19.

The present disclosure is further directed to the following non-limiting clauses.
Clause 1. A method comprising:
   injecting an impure fluid comprising carbon dioxide and at least one impurity into a first subterranean aquifer;
   circulating the impure fluid within the first subterranean aquifer for a period of time sufficient to separate at least a portion of the at least one impurity from the carbon dioxide to produce an at least partially purified fluid comprising the carbon dioxide, the at least partially purified fluid having a lower concentration of the at least one impurity than the impure fluid; and
   removing the at least partially purified fluid from the first subterranean aquifer;
      wherein at least a portion of the at least one impurity remains entrained within the first subterranean aquifer.
Clause 2. The method of clause 1, wherein the at least one impurity comprises hydrogen sulfide.
Clause 3. The method of clause 1 or clause 2, wherein the first subterranean aquifer is a deep saline aquifer.
Clause 4. The method of any one of clauses 1-3, further comprising:
   reinjecting the at least partially purified fluid into a second subterranean aquifer located at a shallower depth than the first subterranean aquifer.
Clause 5. The method of any one of clauses 1-4, wherein the period of time is about 0.1 years to about 10 years.
Clause 6. The method of any one of clauses 1-5, wherein a concentration of the at least one impurity in the impure fluid is about 0.1 wt % to about 20 wt %.
Clause 7. The method of any one of clauses 1-6, wherein a concentration of the at least one impurity in the at least partially purified fluid is about 2 wt % or less.
Clause 8. The method of any one of clauses 1-7, wherein a source of the impure fluid is a hydrocarbon-based power plant.
Clause 9. The method of any one of clauses 1-8, further comprising:
   absorbing geothermal energy from the first subterranean aquifer into the at least partially purified fluid; and
   withdrawing the geothermal energy from the at least partially purified fluid upon removing the at least partially purified fluid from the first subterranean aquifer.
Clause 10. The method of any one of clauses 1-8, further comprising:
   pressurizing the first subterranean aquifer with the impure fluid; and
   producing a formation fluid from the first subterranean aquifer upon pressurizing the first subterranean aquifer with the impure fluid.
Clause 11. The method of clause 10, further comprising:
   withdrawing geothermal energy from the first subterranean aquifer within the formation fluid produced from the first subterranean aquifer.
Clause 12. The method of clause 11, further comprising:
   absorbing additional geothermal energy from the first subterranean aquifer into the at least partially purified fluid; and
   withdrawing the additional geothermal energy from the at least partially purified fluid upon removing the at least partially purified fluid from the first subterranean aquifer.
Clause 13. The method of any one of clauses 1-12, further comprising:
   injecting the at least partially purified fluid into a hydrocarbon-bearing subterranean formation in conjunction with an enhanced oil recovery process.
Clause 14. A method comprising:
   injecting an impure fluid comprising carbon dioxide and at least one impurity into a first subterranean aquifer;
   pressurizing the first subterranean aquifer with the impure fluid;
   producing a formation fluid from the first subterranean aquifer upon pressurizing the first subterranean aquifer; and
   circulating the impure fluid within the first subterranean aquifer for a period of time sufficient to separate at least a portion of the at least one impurity from the impure fluid to produce an at least partially purified fluid comprising carbon dioxide, the at least partially purified fluid having a lower concentration of the at least one impurity than the impure fluid.
Clause 15. The method of clause 14, further comprising:
   removing the at least partially purified fluid from the first subterranean aquifer;
      wherein at least a portion of the at least one impurity remains entrained within the first subterranean aquifer.
Clause 16. The method of clause 15, further comprising:
   absorbing geothermal energy from the first subterranean aquifer into the at least partially purified fluid; and
   withdrawing the geothermal energy from the at least partially purified fluid upon removing the at least partially purified fluid from the first subterranean aquifer.
Clause 17. The method of any one of clauses 14-16, wherein the at least one impurity comprises hydrogen sulfide.
Clause 18. The method of any one of clauses 14-17, wherein the first subterranean aquifer is a deep saline aquifer.
Clause 19. The method of any one of clauses 14-18, further comprising:
   reinjecting the at least partially purified fluid into a second subterranean aquifer located at a shallower depth than the first subterranean aquifer.
Clause 20. The method of any one of clauses 14-19, wherein a concentration of the at least one impurity in the at least partially purified fluid is about 2 wt % or less.
Clause 21. The method of any one of clauses 14-20, wherein the formation fluid absorbs geothermal heat from the first subterranean aquifer, the method further comprising:
   withdrawing the geothermal heat from the formation fluid after production of the formation fluid from the first subterranean aquifer.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by one skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
injecting an impure fluid comprising carbon dioxide and at least one impurity into a first subterranean aquifer;
circulating the impure fluid within the first subterranean aquifer for a period of time sufficient to separate at least a portion of the at least one impurity from the carbon dioxide to produce an at least partially purified fluid comprising the carbon dioxide, the at least partially purified fluid having a lower concentration of the at least one impurity than the impure fluid; and
removing the at least partially purified fluid from the first subterranean aquifer;
wherein at least a portion of the at least one impurity remains entrained within the first subterranean aquifer.

2. The method of claim 1, wherein the at least one impurity comprises hydrogen sulfide.

3. The method of claim 1, wherein the first subterranean aquifer is a deep saline aquifer.

4. The method of claim 1, further comprising:
reinjecting the at least partially purified fluid into a second subterranean aquifer located at a shallower depth than the first subterranean aquifer.

5. The method of claim 1, wherein the period of time is about 0.1 years to about 10 years.

6. The method of claim 1, wherein a concentration of the at least one impurity in the impure fluid is about 0.1 wt % to about 20 wt %.

7. The method of claim 1, wherein a concentration of the at least one impurity in the at least partially purified fluid is about 2 wt % or less.

8. The method of claim 1, wherein a source of the impure fluid is a hydrocarbon-based power plant.

9. The method of claim 1, further comprising:
absorbing geothermal energy from the first subterranean aquifer into the at least partially purified fluid; and
withdrawing the geothermal energy from the at least partially purified fluid upon removing the at least partially purified fluid from the first subterranean aquifer.

10. The method of claim 1, further comprising:
pressurizing the first subterranean aquifer with the impure fluid; and
producing a formation fluid from the first subterranean aquifer upon pressurizing the first subterranean aquifer with the impure fluid.

11. The method of claim 10, further comprising:
withdrawing geothermal energy from the first subterranean aquifer within the formation fluid produced from the first subterranean aquifer.

12. The method of claim 11, further comprising:
absorbing additional geothermal energy from the first subterranean aquifer into the at least partially purified fluid; and
withdrawing the additional geothermal energy from the at least partially purified fluid upon removing the at least partially purified fluid from the first subterranean aquifer.

13. The method of claim 1, further comprising:
injecting the at least partially purified fluid into a hydrocarbon-bearing subterranean formation in conjunction with an enhanced oil recovery process.

14. A method comprising:
injecting an impure fluid comprising carbon dioxide and at least one impurity into a first subterranean aquifer;
pressurizing the first subterranean aquifer with the impure fluid;
producing a formation fluid from the first subterranean aquifer upon pressurizing the first subterranean aquifer; and
circulating the impure fluid within the first subterranean aquifer for a period of time sufficient to separate at least a portion of the at least one impurity from the impure fluid to produce an at least partially purified fluid comprising carbon dioxide, the at least partially purified fluid having a lower concentration of the at least one impurity than the impure fluid.

15. The method of claim 14, further comprising:
removing the at least partially purified fluid from the first subterranean aquifer;
wherein at least a portion of the at least one impurity remains entrained within the first subterranean aquifer.

16. The method of claim 15, further comprising:
absorbing geothermal energy from the first subterranean aquifer into the at least partially purified fluid; and
withdrawing the geothermal energy from the at least partially purified fluid upon removing the at least partially purified fluid from the first subterranean aquifer.

17. The method of claim 14, wherein the at least one impurity comprises hydrogen sulfide.

18. The method of claim 14, wherein the first subterranean aquifer is a deep saline aquifer.

19. The method of claim 14, further comprising:
reinjecting the at least partially purified fluid into a second subterranean aquifer located at a shallower depth than the first subterranean aquifer.

20. The method of claim 14, wherein a concentration of the at least one impurity in the at least partially purified fluid is about 2 wt % or less.

21. The method of claim 14, wherein the formation fluid absorbs geothermal heat from the first subterranean aquifer, the method further comprising:
withdrawing the geothermal heat from the formation fluid after production of the formation fluid from the first subterranean aquifer.
